(19) United States
(12) Patent Application Publication
(10) Pub. No.: US 2023/0381555 A1
(43) Pub. Date: Nov. 30, 2023

(54) AIR FILTER

(71) Applicant: Richard Cartier, Toronto (CA)

(72) Inventor: Richard Cartier, Toronto (CA)

(21) Appl. No.: 18/028,330

(22) PCT Filed: Sep. 24, 2021
(86) PCT No.: PCT/CA2021/051337

§ 371 Date: Mar. 24, 2023

Related U.S. Application Data
(60) Provisional application No. 63/082,673, filed on Sep. 24, 2020.

(51) Int. Cl. A62B 23/02

(52) U.S. Cl. CPC A62B 23/025

(57) ABSTRACT

There is disclosed herein an air filter device for use about the face of a user. The device includes a mask frame, an air filtration assembly engaged with the frame, a tube connected at a first end thereof to the assembly and in sealed relation thereto, a seal member at a second end of the tube substantially distal from the first end and for operation interposition between the tube and a nose on the face, one or more connection ports joined to the seal member, wherein there is defined from the first end of the tube to the openings a channel whereby the assembly and openings are in fluid communication with one another.

### FIELD

This disclosure relates to Personal Protective Equipment (PPE) and, more particularly, to improved air filtration devices, methods of making and using the same.

### BACKGROUND

Global and regional health events, such as the COVID-19 variant of the Corona virus, along with more day to day concerns regarding viral spread, give rise to needs for atypically wide but not necessarily purposefully differential use of PPE. In some situations, such as but not limited to pandemics, users (which may include, for example, health-care providers) may be overwhelmed, their PPE usage needs may increase well beyond typical levels. Further, viruses spread via air-born fluid droplets can be combatted among the general public (or may at least result in a public desire to wear such equipment); for example, by isolation of persons from air-born fluid droplets. Doing so without cumbersome apparatuses such as hazardous materials (hazmat) suits and the like is advantageous, as it balances transmission reduction efficacy with equipment accessibility (e.g., in terms of cost, availability, etc.), allowing health practitioners and others access to some measure of protection (“personal protection”) and transmission rate reduction (“source control”) at a much more accessible price and technology point.

Simple air filtration (with no need for “source control”) is also of significant concern for industrial workers in environments that have airborn dust or particles or droplets as well as in any public environment that has smoke and ash from wildfires, or wind-blown dust, or even dust from volcanic eruptions.

Known varieties of PPE that act as a respirational barrier include, for example, face masks, respirators and similar devices that cover the nose and mouth of the wearer. Such known devices typically filter particles and fluid droplets from the air passing through the fabric (or a portion thereof) of the mask including through filters fitted into patches or in cannisters attached to the mask. The exhalations of the wearer are filtered by such masks that do not have an exhalation bypass so that any airborne droplets are blocked from entering the general atmosphere (“source control”) where they could be inhaled by persons not wearing a mask. Similarly, and in some circumstances more significantly, the inhalations of the wearer are filtered by the mask so that potentially-infected air-born droplets originating elsewhere are blocked from entering the gap between the mask and the wearer's face (“personal protection”) and so are kept from getting into and infecting the wearer's airways through either the oral or nasal route. It will be appreciated by one skilled in the art that the shortcomings of known devices mentioned herein are likewise applicable in respect of respiratory equipment applications involving protection for the airway of the user against, for example, dust, smoke particles and/or fluid droplets.

A major shortcoming of known devices is that the interface between such devices and the users can allow for significant leakage of air or fluid at edges of the mask. This may occur, for example, as the sealing edge of the mask crosses over varying contours or otherwise present discontinuities in coverage between device and user. One example is where the edge of the mask crosses from the smooth contour of one cheek to hump over the bridge of the nose and back down to the smooth contour of the other cheek, there can be significant leakage at each side of the bridge of the nose; and there can be marked differences between the bridge protuberance of different prospective wearers. Another example is where facial hair intervenes between the sealing edge of the mask and the epidermis of the wearer.

Another shortcoming of known devices is that the humidity of exhaled air deposits moisture on at least a large portion if not the entire interior surface of the mask, commonly covering the wearer's face.

Still another shortcoming of known devices is that with most masks the air is filtered in both directions so the filter is filling with droplets and/or particles from both sides and must necessarily have a reduced useable time-span.

Still another shortcoming of known devices is that the wearer's mouth is enclosed within the sealed air-chamber between the mask and the face, muffling verbal communications. Small nuances of speech may become inaudible and the wearer may need to deliberately modify their speaking, perhaps speaking more forcefully at greater volume with careful attention to enunciation and syntax, to communicate clearly. This shortcoming may also dissuade persons from wearing such devices.

Still another shortcoming of known devices is that the wearer's mouth is enclosed within the sealed air-chamber between the mask and the face and is not visible to others. This blocking of view of the mouth makes it impossible for hearing-impaired lip-readers to maintain verbal communication with the wearer.

As such, there is a need for improved air filtration devices to eliminate or mitigate some or all of the aforementioned shortcomings of known devices.

### BRIEF SUMMARY

There is disclosed herein air filters, methods of assembling air filters, and methods of manufacturing air filters.

There is also disclosed herein an air filter device for use about the face of a user. The device includes a mask frame, an air filtration assembly engaged with the frame, a tube connected at a first end thereof to the assembly and in sealed relation thereto, a seal member at a second end of the tube substantially distal from the first end and for operation interposition between the tube and a nose on the face, one or more connection ports joined to the seal member, wherein there is defined from the first end of the tube to the openings a channel whereby the assembly and openings are in fluid communication with one another.

In another embodiment disclosed herein, the device also includes an attachment affixed thereto for securing the filter to the face via use of one or more of a strap, ear hooks and the like.

In another embodiment disclosed herein, the one or more ports comprises a pair of ports, each shaped and configured for sealed engagement with a nostril of the user.

In another embodiment disclosed herein, the connection ports and seal member are formed together/substantially contiguous at respective edges of engagement with one another.

In another embodiment disclosed herein, the mask frame has affixed or formed thereof means for receiving and retaining the attachment for securing the filter to the face.

In another embodiment disclosed herein, the device also includes goggles and/or eye shields formed with the frame.

In another embodiment disclosed herein, the device also includes a veil-bracket, which may be formed with the frame, or a veil-bracket removably mounted by end attachments such as tabs, loops, hooks or the like to the frame, or an integral bracket removably mounted by end attachments such as tabs, loops, hooks or the like to the frame, or a veil removably mounted at its top edge by attachments such as hook & loop fasteners, loops, hooks, snaps, temporary adhesive or the like to the frame.

In another embodiment disclosed herein, the assembly comprises filter media integral to the mask frame.

In another embodiment disclosed herein, the filter media is removably attachable to the mask frame.

In another embodiment disclosed herein, the filter media comprises filter bags

In another embodiment disclosed herein, the member is shaped and configured for engagement with one or more nostrils of the user.

In another embodiment disclosed herein, the member is formed from silicone.

In another embodiment disclosed herein, the tube is connected at the first end thereof to the assembly by way of adhesive.

In another embodiment disclosed herein, the channel whereby the assembly and openings are in fluid communication with one another is substantially circular in cross-section.

In another embodiment disclosed herein, the channel is of substantially uniform cross-sectional area.

### DRAWINGS

FIG. 1 includes assembled and partially exploded views, partially not to scale, of an air filter device;

FIG. 2 is the device of FIG. 1, shown with side air filters;

FIG. 3 is a perspective view of the device of FIG. 1, with a veil-bracket;

FIG. 4 is a front view of another embodiment of an air filter device; and,

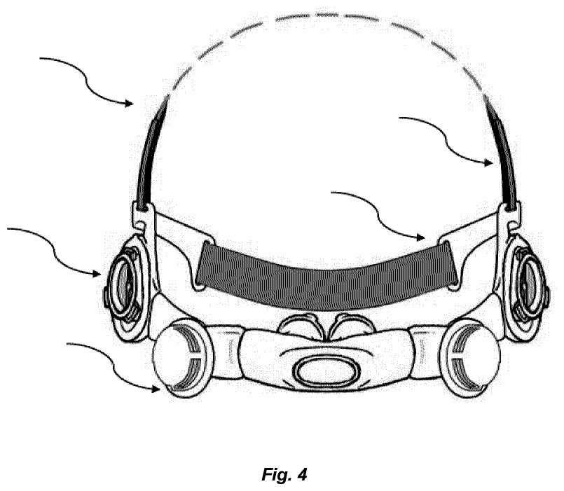

FIG. 5 is a left side view of the device of FIG. 4.

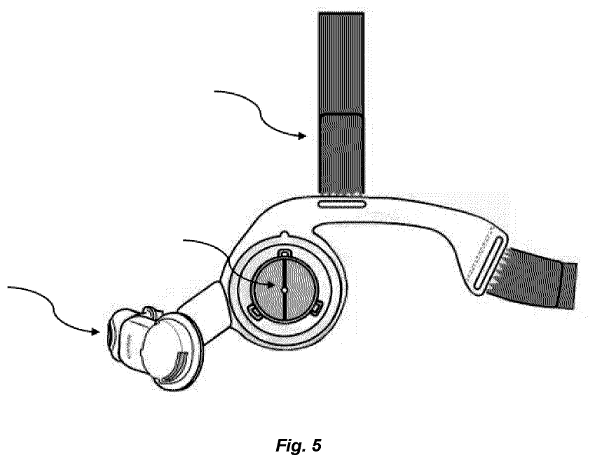

### DESCRIPTION

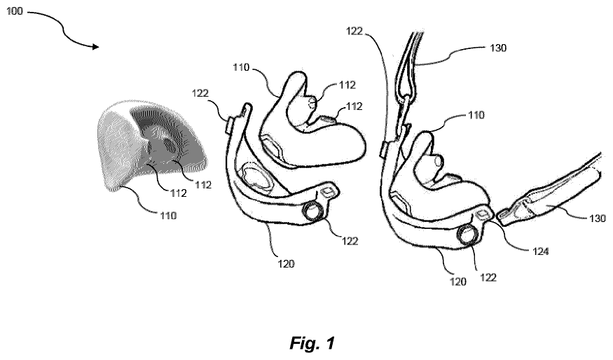

Looking to FIG. 1, there is disclosed herein an air filter device 100 for use about the face of a user. The device 100 includes a mask frame 120, and an air filtration assembly 140 engaged with the frame.

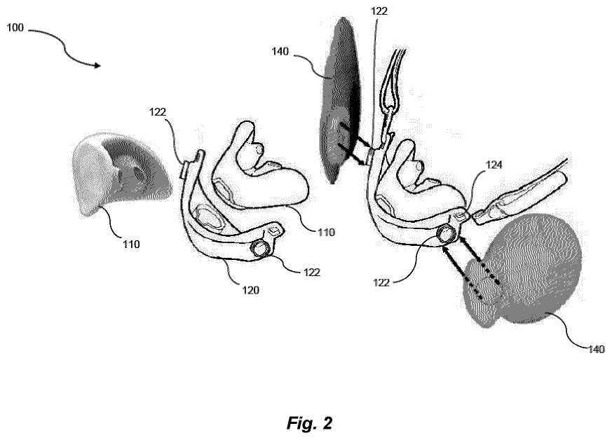

A tube is connected at its first end to the air filtration assembly and is sealed thereto. A seal member 110 at a second end of the tube that is substantially distal from its first end is operationally interposed between the tube and the nose on the face of the user. The member 110 may be shaped and configured for engagement with one or more nostrils of the user, and may be formed from silicone. The assembly 140 may comprises filter media (which may comprise filter bags as shown in FIG. 2) integral to the mask frame 120, and the filter media may be removably attachable to the mask frame 120. The tube may be connected at the first end thereof to the assembly by way of adhesive or via press fit engagement.

One or more of the connection ports 112 are joined to the seal member 110. The ports 112 may comprise a pair of ports 112, each shaped and configured for sealed engagement with a nostril of the user. The ports 112 and the seal member 110 may be formed together or substantially contiguous at respective edges of engagement with one another.

There is defined from the first end of the tube to the openings a channel whereby the air filtration assembly and openings are in fluid communication with one another. The channel whereby the assembly and openings are in fluid communication with one another may be substantially circular in cross-section, and may be of substantially uniform cross-sectional area.

The device 100 further comprises an attachment 124 affixed thereto for securing the filter to the face via use of one or more of a strap 130, ear hooks and the like. One skilled in the art will appreciate that, while straps and hooks are shown, other means of fastening would suffice in some embodiments.

The mask frame 120 may have affixed or formed thereto means for receiving and retaining the attachment 124, and for securing the filter to the face.

The device 100 may further comprise goggles and/or eye shields which may be formed with the frame 120.

The device 100 may also further comprise a veil-bracket 150 that may be formed with the frame and/or removably mounted to the frame by end attachments such as tabs, loops, hooks or the like. The veil 150 may have as part of it an integral bracket 152 and be removably mounted with the frame 120 by end attachments 154 such as tabs, loops, hooks or the like to the frame 120.

In other embodiments, the veil 150 may be removably mounted to the frame 120 at the veil's top edge 156 by attachments such as hook & loop fasteners, loops, hooks, snaps, temporary adhesives or the like to the frame.

The devices 100 function whereby filtered air is delivered specifically to the nose by, for example and without limitation, conically shaped ports 112, into the nostril(s). There are disclosed embodiments wherein, for example, soft silicone is in contact with interior surfaces of nostrils to substantially form a seal, allowing flow of air only through the port 112 and into the nostril. Each port 112 may but need not necessarily be tapered such that one overall size of cone can reasonably fit a wide range of nostril diameters. For example, a trio of overall sizes, e.g., Small, Medium, or Large may reasonably satisfy almost any prospective wearer.

While the majority of people are nose-breathers, which facilitates especially effective use of the disclosed devices, exhaling by mouth (while not mandatory or effective functioning of disclosed devices) may increase the life of the air filter portion of the device. An exhalation bypass valve provided with some embodiments allows for substantially full nasal breathing to provide substantially the same advantage to exhaling by mouth with the same emphasis on “personal protection” and reduction of “source control”.

Devices 100 disclosed herein also provide for positioning of the mouth of the wearer substantially free from the sealed air-chamber behind the air filter 140, rendering user speech more completely audible. Some diminished clarity of especially nasal components of speech may still be possible in limited circumstances. This mouth-freedom would be particularly beneficial to first responders and other front-line workers in positions where risk of infection or other exposure is particularly high while verbal communication could be critical (or in applications where communication between users is necessary whilst maintaining the barrier between the user's airway and surrounding environment).

The aforementioned mouth-freedom allows for view of the wearers mouth and makes it possible for hearing-impaired lip-readers to maintain verbal communication with the wearer. The aforementioned mouth-freedom also allows wearers to ingest food or drink while continuously breathing filtered air through their nostrils.

As the mouth of the wearer is substantially free from the air filter, isolation from air-born fluid droplets compares to respirators with exhalation bypass valves, and becomes primarily “personal protection” to the benefit of the wearer with reduced “source control” because exhaling nasally or exhaling orally is entirely at the discretion of that wearer. An exhalation valve reduces nasal exhalation resistance, which makes it easier to breathe yet provides the same level of protection to the wearer as a respirator that does not have an exhalation valve distinct from an inhalation valve. Healthcare practitioners should understand, that all respirators with exhalation valves do not maintain a sterile environment such as required for an operating theater.

As alluded to above, disclosed devices would include substantially air-tight ducting to the nasal-delivery orifices (which may preferably be substantially conical), from a rigid container with an accessible replaceable air filter. The unit's configuration, and system by which it is positioned onto the wearer is open to some, limited design variability. In some embodiments, there would be provided a configuration in which one air filter is in a container substantially integral with ducting and orifice support feeding both nostril orifices, and a mounting arm-strap-string-elastic would finish. In other embodiments, the entire portion of the device may be comprised of component parts of a pair of goggles or eye shields that could but need not necessarily be integral to a hat or helmet.

Some disclosed embodiments may resemble in some aspects a continuous positive air pressure (CPAP) machine's breathing mask used to treat sleep apnea. Incorporating a mask of such a configuration in a system without externally generated air pressure provides certain advantages. In disclosed devices, filtered air (rather than compressed air) is delivered through the nasal orifices using a pressure gradient generated by reduction of air pressure in the lungs (rather than application of external air pressure) using natural expansion of the chest and lowering of the diaphragm.

Disclosed devices 100 may, in some embodiments, be produced via creation of, for example, a master last/prototype using 3D-printing based on a computer rendering of the design.

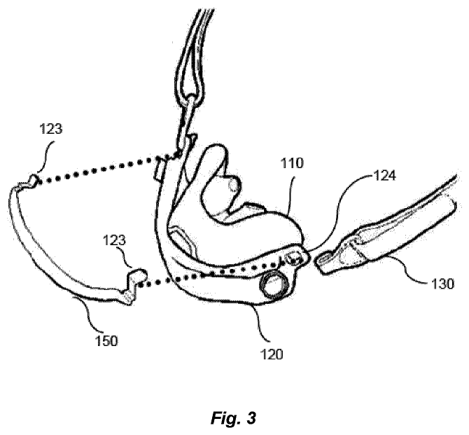

Turning again to the embodiment 100 depicted in FIGS. 1-2, two silicon ports 112 in fluid communication are coupled through the seal member 110 to the mask frame 120 with mounting slots 124 for the head-strap 130 and sealed ducting leading from a filter-connector 122 on each side. An optional veil bracket 150 is shown in FIG. 3 and operationally mounts its end tabs 123 to the frame 120 at the head-strap slots 124 (together with the head-strap clips), and a veil (not shown; functioning as “source control”, for example, as an oral spray barrier) descending from this bracket 150 may be plain or printed with, for example and without limitation, the logo of a first responder, an image of the badge and/or badge number of an individual, or other information. The veil could be transparent to make it possible for hearing-impaired lip-readers to maintain verbal communication with the wearer.

To use the disclosed devices, it is placed on the face of the user with the orifices in the user's nostrils. The user then breathes in through the nostrils and may exhale through the nostrils or the mouth.

Embodiments disclosed herein may also in some cases function in part in the manner of therapeutic medical equipment used to deliver indicated gaseous medicines or compressed air into respiratory systems of patients. It will be appreciated by a person skilled in the art that plain filtered air may be consciously inhaled through the nose whilst the inhaling person deliberately chooses not to inhale through the mouth. However, again, known devices fail to disclose or suggest, among other things, the use of, for example, facial-mask components in systems without medications or externally generated air pressure. Systems and devices disclosed herein provide for filtered air (i.e., rather than gaseous medications and/or compressed air provided in a ‘loose’ or unsealed fashion) is delivered through the nose of the user using a pressure gradient generated by reduction of air pressure in the lungs (rather than application of external air pressure) using natural expansion of the chest and lowering of the diaphragm.

Other embodiments disclosed herein provide for performance somewhat similar to CPAP machines and masks. In the original application continuous prescription-regulated air pressure is applied to incoming air (that is humidified for comfort) to induce the patient's airway to stay open during sleep. A novel aspect hereof is to use the facial-mask component of this configuration in a system without externally generated air pressure or added water vapor. With my invented approach filtered air (rather than compressed and humidified air) is delivered through the silicon orifices using a pressure gradient generated by reduction of air pressure in the lungs (rather than application of external air pressure) using natural expansion of the chest and lowering of the diaphragm.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically, and by way of example, although the headings refer to a “Field” such claims should not be limited by the language under this heading to describe the so-called technical field. Further, a description of technology in the “Background” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

All of the devices, systems and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. Air filters, as disclosed herein.

2. Methods of assembling air filters, as disclosed herein.

3. Methods of manufacturing air filters, as disclosed herein.

4. An air filter device for use about the face of a user, the air filter device comprising:
a. a mask frame;
b. an air filtration assembly engaged with the frame;
c. a tube connected at a first end thereof to the air filtration assembly and in sealed relation thereto;
d. a seal member at a second end of the tube substantially distal from the first end and for operation interposition between the tube and the nose on the face;
e. one or more connection ports joined to the seal member;
wherein there is defined from the first end of the tube to the openings a channel whereby the air filtration assembly and openings are in fluid communication with one another.

5. The device of claim 4, further comprising an attachment affixed thereto for securing the filter to the face via use of one or more of a strap, ear hooks and the like.

6. The device of claim 1, wherein the one or more ports comprises a pair of ports, each shaped and configured for sealed engagement with a nostril of the user.

7. The device of claim 6, wherein the connection ports and seal member are formed together/substantially contiguous at respective edges of engagement with one another.

8. The device of claim 5, wherein the mask frame has affixed or formed thereof means for receiving and retaining the attachment for securing the filter to the face.

9. The device of claim 8, further comprising goggles and/or eye shields formed with the frame.

10. The device of claim 4, further comprising one or more of:
a. a veil-bracket formed with the frame;
b. a veil-bracket removably mounted by end attachments such as tabs, loops, hooks or the like to the frame;
c. a veil with integral bracket removably mounted by end attachments such as tabs, loops, hooks or the like to the frame; and,
d. a veil removably mounted at its top edge by attachments such as hook & loop fasteners, loops, hooks, snaps, temporary adhesive or the like to the frame.

11. The device of claim 1, wherein the assembly comprises filter media integral to the mask frame.

12. The device of claim 1, wherein the filter media is removably attachable to the mask frame.

13. The device of claim 11 or 12, wherein the filter media comprises filter bags

14. The device of claim 13, wherein the member is shaped and configured for engagement with one or more nostrils of the user.

15. The device of any one of claims 4, 13, and 14, wherein the member is formed from silicone.

16. The device of claim 1, wherein the tube is connected at the first end thereof to the assembly by way of adhesive.

17. The device of claim 1, wherein the channel whereby the assembly and openings are in fluid communication with one another is substantially circular in cross-section.

18. The device of claim 1, wherein the channel is of substantially uniform cross-sectional area.
